(19) United States
(12) Patent Application Publication
(10) Pub. No.: US 2006/0212717 A1
(43) Pub. Date: Sep. 21, 2006

(54) Rental authentication system

(75) Inventors: Kimikazu Ito, Kawasaki (JP); Akira Wakabayashi, Kawasaki (JP); Nobuhito Kanai, Tokyo (JP); Ikuo Mutou, Tokyo (JP); Kazuo Takaku, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki (JP); FUJITSU FRONTECH LIMITED, Tokyo (JP)

(21) Appl. No.: 11/320,844

(22) Filed: Dec. 30, 2005

(30) Foreign Application Priority Data
Mar. 18, 2005 (JP) JP2005-080631

(51) Int. Cl. H04K 1/00; H04L 9/00

(52) U.S. Cl. 713/186

(57) ABSTRACT

To provide a technology that prevents a rental for a defrauding purpose by specifying a borrower through biometric authentication and conducting the authentication based on a usage past record of the borrower. Biometric information of a borrower is received from the terminal, a blacklist recorded with biometric information of beware-of persons is referred to, authentication as to whether the biometric information of the borrower matches with the blacklist or not is done, a past record database recoded with the biometric information of the borrowers having usage past records is referred to, there is made the authentication as to whether the biometric information of the borrower who does not match with the blacklist matches with the past record database or not, the terminal is notified of approval or non-approval for a rental operation on the basis of results of the authentication, the past record database is updated if the rental operation is approved.

### BACKGROUND OF THE INVENTION

The invention relates to a technology for authenticating a borrower when renting.

A rent-a-car trader has hitherto conducted renting by checking identity of the borrower from a driver's license.

Then, in case the rented car is not returned, the rent-a-car trader claimed the person identified by the driver's license to return the rented car.

### SUMMARY OF THE INVENTION

Recently, however, there occurs an incident of car defrauding, wherein one single person rents a plurality of cars but does not return the cars.

Such being the case, the invention provides a technology that prevents a rental for a defrauding purpose by specifying a borrower through biometric authentication and determining approval or non-approval for a rental operation according to a usage past record of the borrower.

The invention adopts the following configurations in order to solve the problems.

Namely, a rental authentication system of the invention is configured by connecting an authentication device to a plurality of terminals via a network,

the authentication device comprising:

a biometric information receiving module receiving biometric information of a borrower from the terminal;

a first authentication module referring to a blacklist recorded with biometric information of beware-of persons, and authenticating as to whether the biometric information of the borrower matches with the blacklist or not;

a second authentication module referring to a past record database recoded with the biometric information of the borrowers having usage past records, and authenticating as to whether the biometric information of the borrower who does not match with the blacklist, matches with the past record database or not;

a result notifying module notifying the terminal of approval or non-approval for a rental operation on the basis of results of the authentication by the first authentication module and by the second authentication module; and

an update module updating the past record database if the rental operation is approved,

the terminal comprising:

a biometric information reading module reading the biometric information of the borrower;

a biometric information transmitting module transmitting the biometric information to the authentication device; and

a result receiving module receiving the approval or non-approval of the rental operation on the basis of the result of the authentication from the authentication device.

Further, a rental authentication method of the invention is executed by an authentication device and a plurality of terminals that are connected via a network,

the authentication device executing:

receiving biometric information of a borrower from the terminal;

referring to a blacklist recorded with biometric information of beware-of persons, and authenticating as to whether the biometric information of the borrower matches with the blacklist or not;

referring to a past record database recoded with the biometric information of the borrowers having usage past records, and authenticating as to whether the biometric information of the borrower who does not match with the blacklist, matches with the past record database or not;

notifying the terminal of approval or non-approval for a rental operation on the basis of results of the authentication; and

updating the past record database if the rental operation is approved,

the terminal executing:

reading the biometric information of the borrower;

transmitting the biometric information to the authentication device; and

receiving the approval or non-approval of the rental operation on the basis of the result of the authentication from the authentication device.

Moreover a authentication device of the invention comprises:

a biometric information receiving module receiving biometric information of a borrower from a terminal;

a first authentication module referring to a blacklist recorded with biometric information of beware-of persons, and authenticating as to whether the biometric information of the borrower matches with the blacklist or not;

a second authentication module referring to a past record database recoded with the biometric information of the borrowers having usage past records, and authenticating as to whether the biometric information of the borrower who does not match with the blacklist, matches with the past record database or not;

a result notifying module notifying the terminal of approval or non-approval for a rental operation on the basis of results of the authentication by the first authentication module and by the second authentication module; and

an update module updating the past record database if the rental operation is approved.

Still further, a rental authentication method is executed by an authentication device connected to a plurality of terminals via a network,

the authentication device executing:

receiving biometric information of a borrower from the terminal;

referring to a blacklist recorded with biometric information of beware-of persons, and authenticating as to whether the biometric information of the borrower matches with the blacklist or not;

referring to a past record database recoded with the biometric information of the borrowers having usage past records, and authenticating as to whether the biometric information of the borrower who does not match with the blacklist, matches with the past record database or not;

notifying the terminal of approval or non-approval for a rental operation on the basis of results of the authentication; and

updating the past record database if the rental operation is approved.

Furthermore, the invention may also be a rental authentication program for making a computer execute the rental authentication method. Still further, the invention may also be a readable-by-computer recording medium recorded with this program. The computer is made to read and execute the program on this recording medium, whereby the functions thereof can be provided.

Herein, the recording medium readable by the computer connotes a recording medium capable of storing information such as data, programs, etc. electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the recording mediums fixed within the computer.

According to the invention, it is possible to provide a technology that prevents a rental for a defrauding purpose by specifying a borrower through biometric authentication and conducting the authentication based on a usage past record of the borrower.

### BRIEF DESCRIPTION OF THE DRAWINGS

FIG. 1 is a schematic view of an architecture of the invention.

FIG. 2 is a function block diagram of a shared authentication server.

FIG. 3 is a function block diagram of a shop PC.

FIG. 4 is an explanatory diagram of reading biometric information.

FIG. 5A-5B are explanatory diagrams of a rental authentication method in a first embodiment.

FIG. 6A-6B are explanatory diagrams of the rental authentication method in a second embodiment.

FIG. 7 is a diagram showing an example of a database.

### DETAILED DESCRIPTION OF THE PREFERRED EMBODIMENT

A best mode for carrying out the invention will hereinafter be described with reference to the drawings. A configuration of an embodiment is an exemplification, and the invention is not limited to the configuration of the embodiment.

### First Embodiment

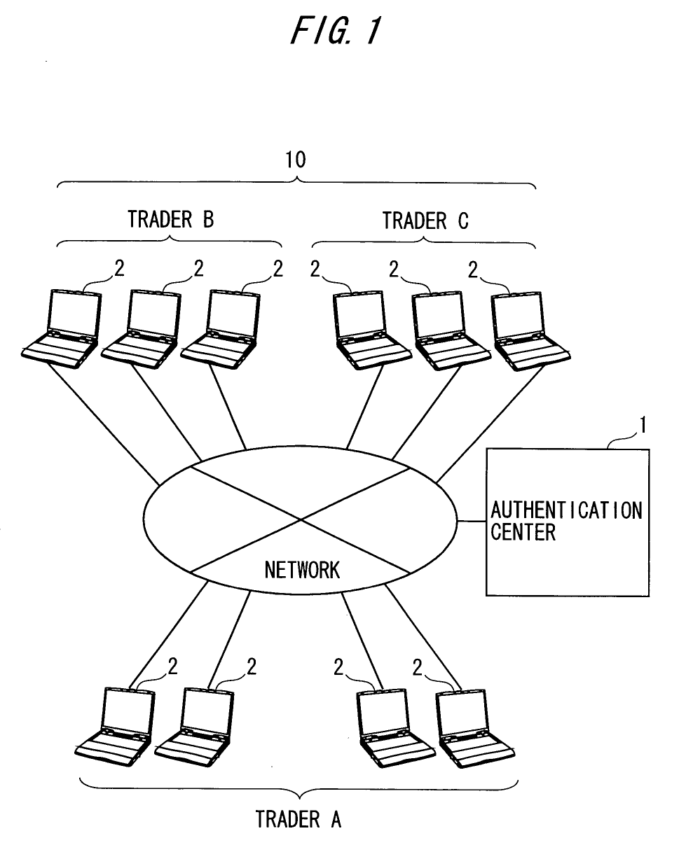

FIG. 1 is a schematic view of a rental authentication system according to the invention. A rental authentication system 10 in this example is configured by shop PCs (terminals) 2 installed at respective shops of a plurality of rent-a-car traders and a shared authentication server (authentication device) 1 installed at an authentication center undertaking authentication from each rent-a-car trader, which are connected to each other via a network such as the Internet.

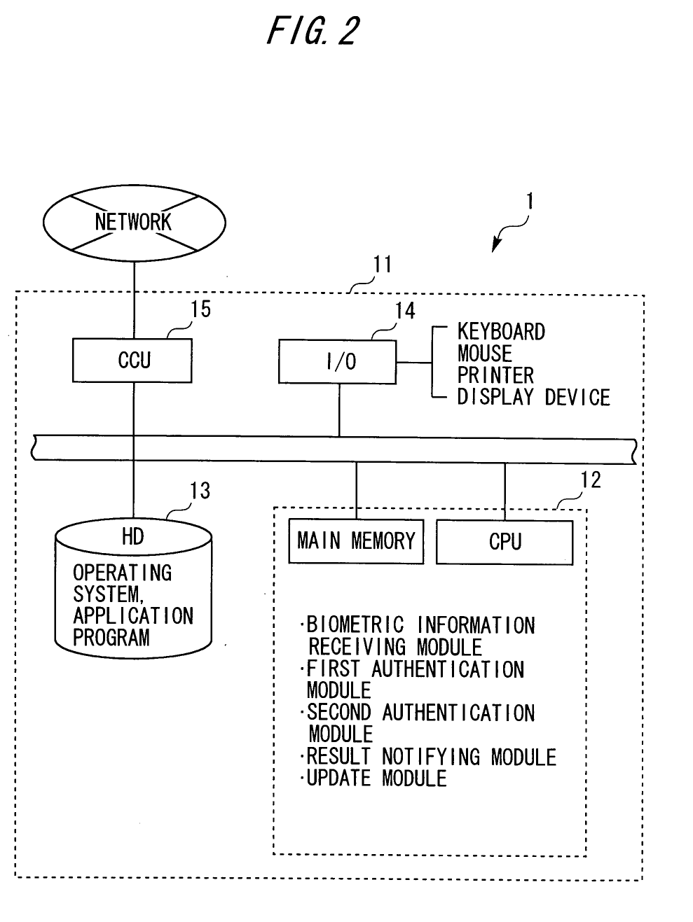

FIG. 2 is a schematic diagram of a configuration of the shared authentication server 1 in the first embodiment. As shown in FIG. 2, the shared authentication server 1 is a general-purpose computer including, within a main body 11, an arithmetic processing unit 12 constructed of a CPU (Central Processing Unit), a main memory, etc., a storage unit (hard disc) 13 stored with data and software for an arithmetic process, an input/output port 14, a communication control unit (CCU) 15, and so on.

An input device such as a keyboard and a mouse and an output device such as a display device and a printer, are properly connected to the input/output port 14.

The communication control unit 15 executes control for performing communications with other computers via the network.

The storage unit 13 is preinstalled with an operating system (OS) and an application program (a rental authentication program) Further, the storage unit 13 has a borrower DB (a past record database) stored with biometric information and past usage records (past record information) of borrowers, and has also a blacklist recorded with biometric information of borrowers who became beware-of persons in the past. The past record information stored on this borrower DB is exemplified by a name and a numerical quantity of the rented object, a rental period, return/non-return of the rented object, a return date/time, trouble/non-trouble during the rental period, etc. The borrower DB enabling the past record information to be specified by the biometric information is effective in rental management of the object that is not normally rented by a plurality of borrowers at the same time as in the case of the rent-a-car in the first embodiment. Furthermore, information showing whether the biometric information is recorded on the borrower DB or not may also be used as the past record information. Namely, in the first embodiment, the biometric information is registered when rented and is deleted from the borrower DB when returning the rental object, whereby if the biometric remains recorded on the borrower DB, this specifies being rented, and, if the biometric information is unrecorded on the borrower DB, this specifies not being rented.

The arithmetic processing unit 12 properly reads the OS and the application program from the storage unit 13 and executes the OS and the application program, and executes the arithmetic process of information inputted from the input/output port 14 and from the communication control unit 15 and of information read from the storage unit 13, thereby functioning also as a biometric information receiving module, a first authentication module, a second authentication module, a result notifying module and an update module.

The arithmetic processing unit 12, as this biometric information receiving module, receives the biometric information of the borrower from the shop PC via the communication control unit 15.

The arithmetic processing unit 12, as the first authentication module, refers to the blacklist recorded with the biometric information about the beware-of persons, and thus authenticates as to whether the biometric information of the borrower matches with the blacklist or not.

The arithmetic processing unit 12, as the second authentication module, further compares the biometric information of the borrower, which does not match with the blacklist, with the biometric information stored on the borrower DB on the storage unit 13, and thus authenticates as to whether the matched information exists or not.

The arithmetic processing unit 12, as the result notifying module, notifies the terminal 2 of information showing approval or non-approval (which will hereinafter be, for the convenience's sake, referred to as rental approval/non-approval or simply also as approval/non-approval) for a rental operation on the basis of the results of authentication by the first authentication module and the second authentication module. For example, as the result of the authentication by the fist authentication module, if the biometric information matches with the blacklist, this shows a beware-of person, and hence notification of the non-approval for the rental is issued. Further, as the result of the authentication by the second authentication module, if the biometric information matches with the borrower DB, this shows being rented already, next rental is not therefore approved, and, whereas if the biometric information does not match with the borrower DB, this showing not being rented, the next rental is therefore approved, whereby the shop PC is notified of this information.

The arithmetic processing unit 12, as the update module, if the rental operation shows the approval, updates the past usage record by adding the biometric information of the borrower to the borrower DB, and, whereas if not approved, adds the biometric information of the borrower to the blacklist.

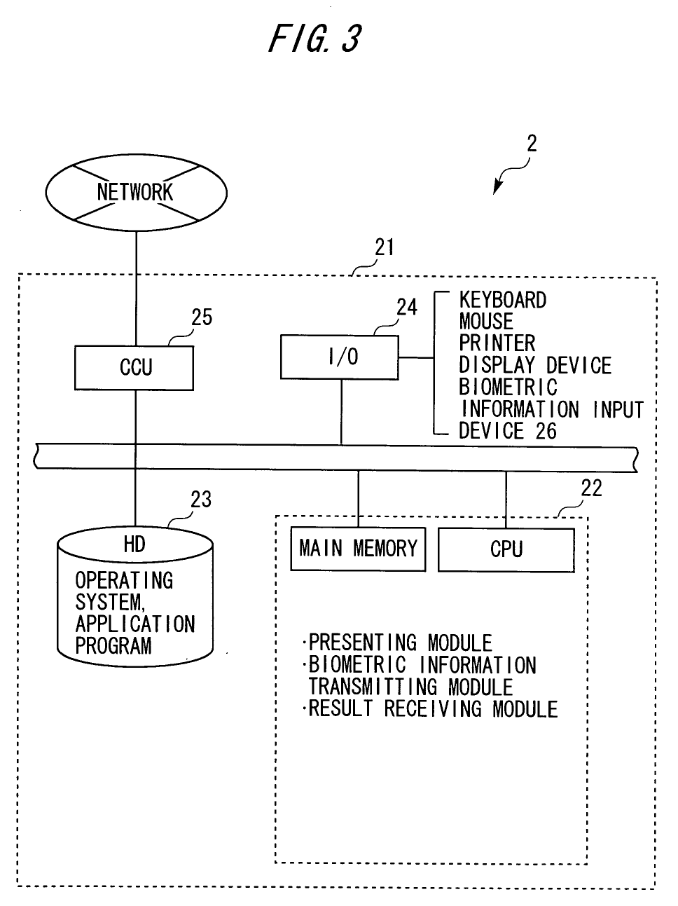

Further, FIG. 3 is a schematic diagram of a configuration of the shop PC 2 in the first embodiment. As shown in FIG. 3, the shop PC 2 is a general type of computer including, within a main body 21, an arithmetic processing unit 22 constructed of a CPU (Central Processing Unit), a main memory, etc., a storage unit (hard disc) 23 stored with data and software for an arithmetic process, an input/output port 24, a communication control unit (LAN adaptor) 25, and so on.

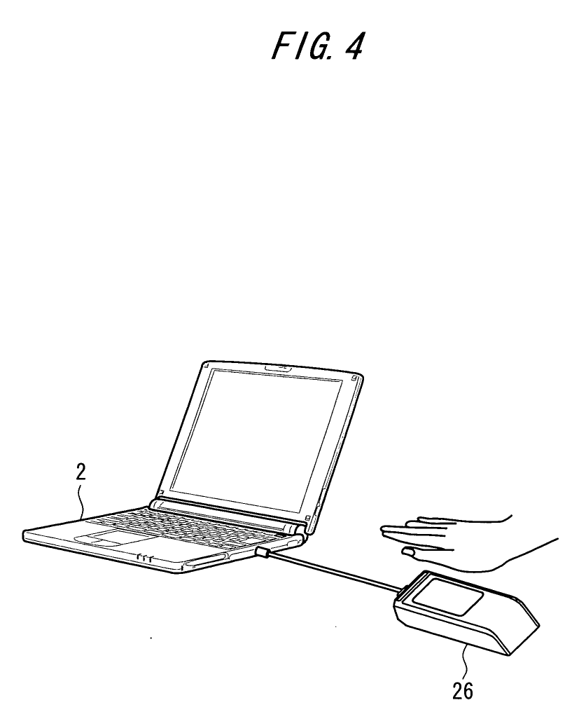

Connected properly to the input/output port 24 are an input device such as a keyboard, a mouse (an identity information input unit and an approval input unit) and a biometric information input device (a biometric information reading unit) 26, an output device such as a display device and a printer and an input/output device such as a CD-ROM drive. The biometric information input device 26 reads the biometric information of the borrower, and, in this example, datamizes the biometric information by, as illustrated in FIG. 4, capturing an image of a vein pattern of the borrower's palm held up by employing near infrared rays. This vein pattern of whichever hand, left or right, may be read, or the vein patterns of both hands may also be read. Further, a guide may be installed in a place where the hand is put on so that the pattern can be read with the same (image) quality every time.

The communication control unit 25 executes control for performing the communications with other computers via a network.

The storage unit 23 is preinstalled with an operating system (OS) and application software. Further, the storage unit 23 is stored with a customer database (DB) registered with the identify information of the borrower and the biometric information of the borrower on a borrower-by-borrower basis by associating these items of information with each other.

The arithmetic processing unit 22 properly reads the OS and the application program from the storage unit 23 and executes the OS and the application program, and executes the arithmetic process of information inputted from the input/input port 24 and from the communication control unit 25 and information read from the storage unit 23, thereby functioning also as a presenting module, a biometric information transmitting module and a result receiving module.

The arithmetic processing unit 22, as this presenting module, extracts, from the customer DB, the identity information associated with the biometric information read by the biometric information reading module, and presents the identity information to an operator by displaying this information on the display device.

The arithmetic processing unit 22, as this biometric information transmitting module, transmits the biometric information read by the biometric information input device 26 to the authentication device.

The arithmetic processing unit 22, as the result receiving module, receives the rental approval/non-approval from the authentication device 1, and conducts the rental operation based on this received information. For instance, the rental approval is displayed, the customer database is updated, and so forth. Note that the rental operation is not limited to this operation and may also be a process occurred as a concomitant of the rental such as outputting a rental slip (cutform) written with a name, an address, a (driver's) license number, etc. of the borrower by reading the identity information, and updating the database for managing a stock (cars that can be rented).

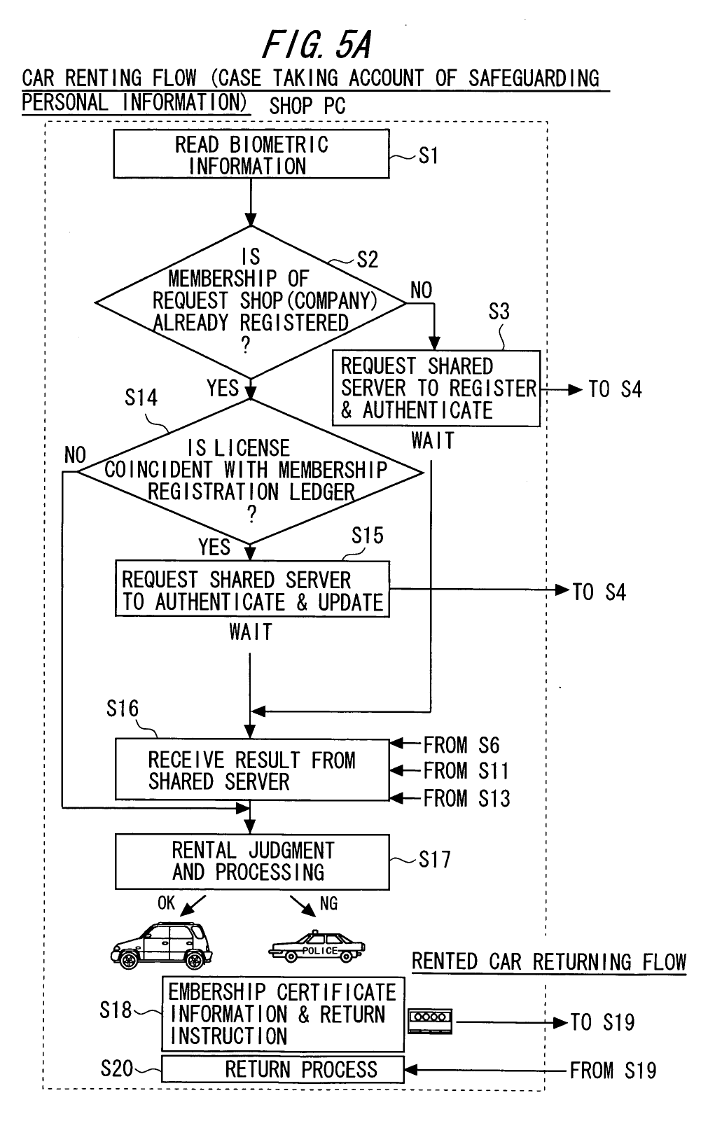

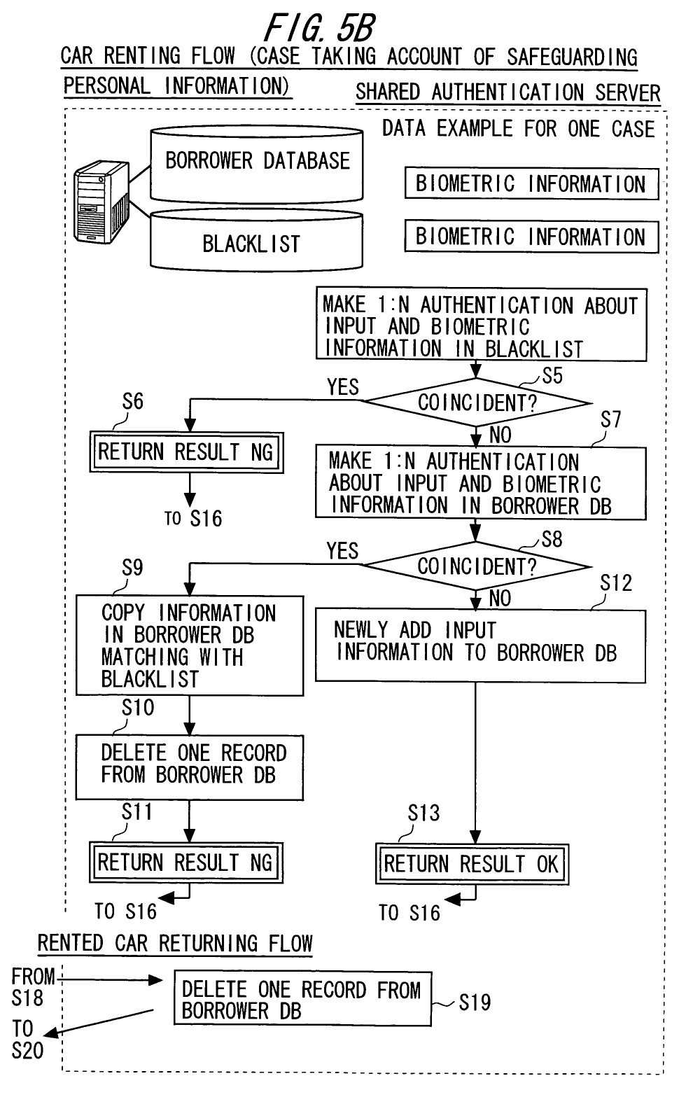

Then, the rental authentication method executed in the system 10 having the architecture described above will be explained with reference to FIG. 5.

When the borrower visits the shop of the rent-a-car trader, the shop PC 2 reads, by the biometric information reading module, the biometric information (the vein patterns of the both hands) of the borrower (step 1, which will hereinafter be abbreviated such as S1) Then, the shop PC 2 judges whether or not the readout biometric information is already registered on the customer DB (S2), and, if registered, requests the shared authentication server 1 to authenticate by transmitting the biometric information through the function of the biometric information transmitting module (S3).

Further, if the readout biometric information is already registered on the customer DB, the presenting module reads the identity information associated with the biometric information and displays the identity information on the display device, thus prompting the operator to check the identity. The operator checks whether or not the registered identity information such as the address, the name and the (driver's) license number is coincident with the information of the license of the borrower, and inputs approval or non-approval to the shop PC 2 from the keyboard and the mouse. Herein, the shop PC 2, if the approval is inputted, requests the shared authentication server 1 to authenticate by transmitting the biometric information through the function of the biometric transmitting module (S14, S15).

The shared authentication server 1 receiving, by the biometric information receiving module, the biometric information of the borrower from the shop PC 2, refers to the blacklist on the storage unit 13 and thus authenticates, by the first authentication module, as to whether the received biometric information matches with the blacklist or not (S4). Note that the blacklist is sorted out according to the similarity beforehand, and the shared authentication server 1, to being with, extracts a plurality of candidates (patterns) with the vein pattern of the right hand, and thereafter narrows down the candidates with the vein pattern of the left hand. Then, the shared authentication server 1, as a result of the authentication by the first authentication module, if the received biometric information matches with the blacklist, the result notifying module, judges this not to be approved (S5), and sends this non-approval to the requester shop PC 2 (S6).

While on the other hand, if the received biometric information does not match with the blacklist, the second authentication module refers to the borrower DB and thus authenticates as to whether the biometric information fulfills (the condition) or not (S7). The result notifying nodule judges whether the rental is approved or not approved, depending on whether the past record information of the borrower specified by the result of the authentication by the second authentication module fulfills a predetermined condition or not. In this example, a rental object is a car, and the individual borrower does not normally rent a plurality of cars at the same time, so that the condition is that the borrower has already got none of the rental. Namely, if the received biometric information is not already registered on the borrower DB, the approval is given, and, whereas if registered, the non-approval is given (S8).

Herein, if the received biometric information is already registered on the borrower DB, the result notifying module notifies the update module of the non-approval, and the update module adds the biometric information to the blacklist (S9) and deletes the biometric information from the borrower DB (S10). Further, the result notifying module sends the non-approval of the rental to the shop PC 2 (S11).

Moreover, whereas if the received biometric information is not registered on the borrower DB, the result notifying module notifies the update module of the approval, and the update module effects updating by adding the biometric information to the borrower DB (S12). Further, the result notifying module sends the approval of the rental to the shop PC 2 (S13).

On the other hand, the shop PC 2 receives the rental approval/non-approval based on the result of the authentication, and gets the approval/non-approval displayed on the display device (S16). The operator performs corresponding manipulations for the borrower by seeing the rental approval/non-approval displayed on the display device. For instance, when the rental approval is displayed, the operator inputs necessary items such as a rental car type and a rental period to the shop PC 2.

Further, the shop PC 2 receiving the rental approval adds, by way of the rental operation, information with a purport of being rented to the identity information of the customer entered on the customer DB together with the necessary items. Moreover, also in the case of receiving the non-approval for the rental, the shop PC 2 registers information, with a purport of not being approved, in the identity information of the customer (S17). Through this operation, if the customer has already borrowed at the same shop or if not approved in the past, it is possible to confirm in step 14 that the rental is not approved without even undergoing the authentication, and this prevents futile traffic from occurring in the shared authentication server 1.

Further, if the biometric information unregistered on the customer DB is authenticated in step 2, the identity information of the borrower is inputted from on the keyboard etc. and is so registered as to be associated with the biometric information on the customer DB.

Then, the borrower returns the rented car and inputs the information (the (driver's) license, a membership number, etc. of the borrower) with a purport of having returned to the shop P 2, and the shop PC 2 sends the borrower's biometric information associated with this information to the shared authentication server 1 and requests the server 1 to delete the past record information (S18).

The shared authentication server 1 receiving this delete request deletes the biometric information from the borrower DB (S19).

Then, the shop PC 2 executes a return process such as deleting the borrower information with the purport of being rented from the customer DB (S20).

As described above, according to the first embodiment, if the identical person tries to receive the rental without returning the car, the rental is not approved, thereby enabling a theft to be reduced.

### Second Embodiment

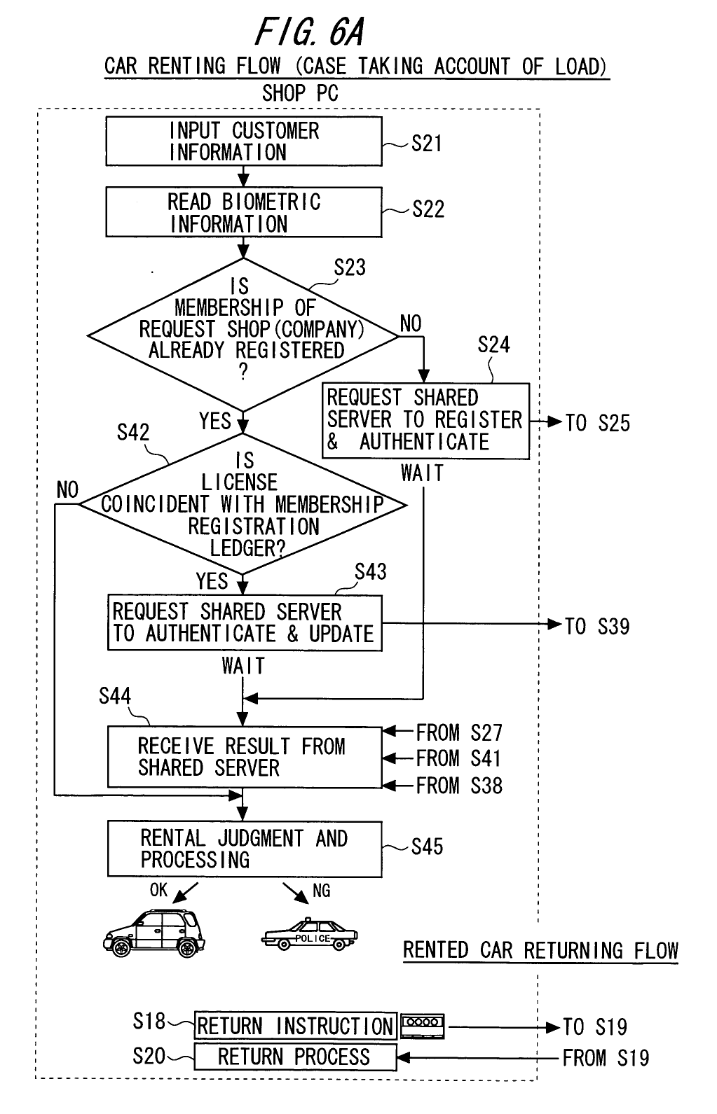

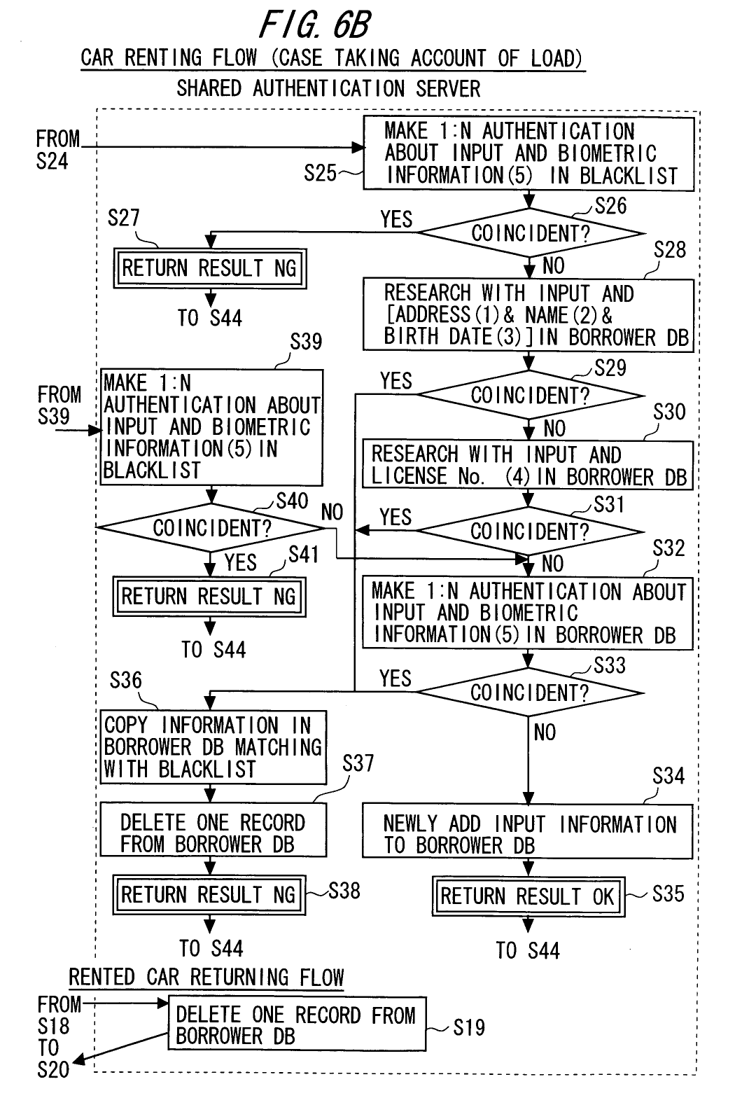

FIG. 6 is an explanatory diagram of the rental authentication method by way of a second embodiment according to the invention. The second embodiment is different from the first embodiment in terms of a point that the authentication is conducted based on the identity information before the authentication based on the biometric information, and other configurations are the same. Therefore, the same components as those described above are marked with the same numerals and symbols, and the repetitive explanations are omitted.

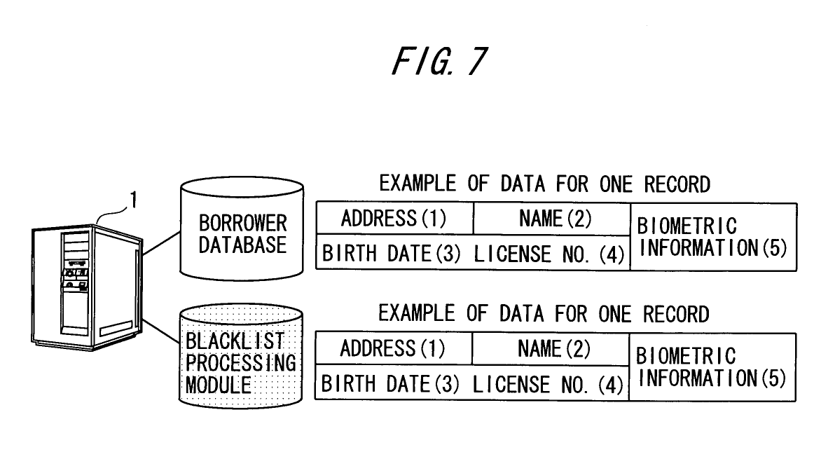

It should be noted that in the second embodiment, the shared authentication server 1 authenticates the identity information, and therefore records, as shown in FIG. 7, the identity information such as an address, a name, a date of birth, a (driver's) license number, etc. of the borrower and the biometric information in a way that associates the identity information and the biometric information with each other.

When the borrower visits the shop of the rent-a-car trader, at first, the operator inputs the identity information of the borrower to the shop PC 2. The shop PC 2 receiving the input of this identity information reads the biometric information of the borrower by the biometric information reading module (S21, S22). Then, the shop PC 2 judges whether or not the readout biometric information is already registered on the customer DB (S23), and, if not registered, requests the shared authentication server 1 to authenticate by transmitting, through the function of the biometric information transmitting module, the biometric information and the identity information to the server 1 (S24).

The shared authentication server 1, which has received, by the biometric information receiving module, the biometric information of the borrower from the shop PC 2, by the first authentication module, refers to the blacklist on the storage module 13 and authenticates as to whether the received biometric information matches with the blacklist or not (S25). As a result of this authentication, if the biometric information matches with the blacklist, the notifying module judges that the rental is not approved (S26), and sends this non-approval to the requester shop PC 2 (S27). Whereas if the received biometric information does not match with the blacklist, the second authentication module refers to the borrower DB and authenticates as to whether the address, the name and the date of birth in the identity information match therewith or not (S28). If these items of information do not match, the second authentication module authenticates next as to whether the license number of the borrower matches with the borrower DB or not (S30). Then, if those items do not match therewith, the second authentication module refers to the borrower DB and authenticates as to whether the biometric information matches with the borrower DB (S32).

As a result of this authentication by the second authentication module, if the biometric information does not match with the borrower DB, the result notifying module makes judgment of not being rented (S33) and notifies the update module of the rental approval, and the update module updates the borrower DB by adding the biometric information to the borrower DB (S34). Further, the result notifying module sends the rental approval to the requester shop PC 2 (S35).

While on the other hand, if the matched information is already registered on the borrower DB in steps 29, 31 and 33, the result notifying module makes judgment of being rented and notifies the update module that the rental is not approved, and this update module adds the biometric information to the blacklist (S36) and deletes the biometric information from the borrower DB (S37). Further, the result notifying module sends the non-approval for the rental to the requester shop PC 2 (S38).

Moreover, instep 23, if the readout biometric information is already registered on the customer DB, the presenting module reads the identity information associated with the biometric information and gets the identity information displayed on the display device, thus prompting the operator to check the identity. The operator checks whether or not the registered pieces of identity information such as the address, the name and the license number are coincident with those in the license of the borrower, and inputs the approval or non-approval to the shop PC 2 from the keyboard and the mouse. Herein, the shop PC 2, if the approval is inputted, transmits, through the function of the biometric information transmitting module, information with a purport that the identity has already been checked together with the biometric information to the shared authentication server 1 and requests the server 1 to authenticate (S42-S43).

The shared authentication server 1, which has received, by the biometric information receiving module, the biometric information of the borrower together with the information with the purport that the identity has already been checked from the shop PC 2, by the first authentication module 1, refers to the blacklist on the storage unit 13 and thus authenticates as to whether the received biometric information matches with the blacklist or not (S39). If the biometric information matches with the blacklist, the result notifying module judges that the rental is not approved (S40), and sends this result to the requester shop PC 2 (S41). Whereas if the received biometric information does not match with the blacklist, the second authentication module refers to the borrower DB and thus authenticates depending on whether the biometric information is already registered or not (S32-S35). At this time, the identity information has already been checked on the side of the shop, and hence steps 25-31 are omitted. Note that whether steps 25-31 are omitted or not is judged based on whether or not the information showing the purport of the identity being already checked has been received together with the biometric information (unillustrated). Thus, in this example, whether steps S25-31 are omitted or not is judged based on the existence or non-existence of the information showing the purport of the identity being already checked, however, without being limited to this configuration, in the case of receiving the identity information and the biometric information, another configuration may be such that the processing goes to step 25 and, when receiving only the biometric information, further goes to step 39.

Moreover, as a result of the authentication in step 39, if the biometric information matches with the blacklist, the result notifying module judges that the rental is unapproved (S40), and notifies the shop PC 2 (S41).

On the other hand, the result receiving module of the shop PC 2 receives the rental approval/non-approval based on the result of the authentication, and gets the rental approval/non-approval displayed on the display device (S44). The operator performs corresponding manipulations for the borrower by seeing the rental approval/non-approval displayed on the display device.

Further, the shop PC 2, when receiving the rental approval, by way of the rental operation, adds information with a purport of being rented to the identity information of the customer entered on the customer DB together with the items inputted instep 21. Moreover, also in the case of receiving the non-approval for the rental, the shop PC 2 registers information, with a purport of not being approved, in the identity information of the customer (S45).

Then, when the borrower returns the rented car, the return process (S18-S20) is executed in the same way as the above-mentioned.

As described above, according to the second embodiment, if the identical person tries to receive the rental without returning the car, the rental is not approved, thereby enabling a theft to be reduced.

Further, in the second embodiment, before the authentication based on the biometric information having a comparatively large quantity of information, the authentication based on the identity information having a comparatively small quantity of text-formatted information is conducted, and consequently a period of time related to the authentication can be reduced.

### OTHERS

The invention is not limited to only the illustrated examples given above and can be, as a matter of course, changed in a variety of forms in the range that does not deviate from the gist of the invention.

For example, the embodiments have exemplified the rental of the car, however, the invention, without being limited to this rental, may be a system for authenticating the rental of other objects such as a video tape, a DVD, clothing, an accessory and travel goods. At this time, a condition for judging the approval/non-approval of the rental may be set properly corresponding to the object to be rented. For example, in the case of the rental of the video tapes or the DVDs, titles and the number of the on-rental video tapes or DVDs are recorded in association with the biometric information as a usage past record, and the rental is approved if the usage past record specified by the biometric information is equal to or smaller than a predetermined count but is not approved if over the predetermined count and may not be approved in the case of tries to rent the object given the same title plural number of times.

Further, even the configurations given in the following Notes can acquire the same effects as those in the embodiments discussed above. Still further, the components thereof can be combined to the greatest possible degree.

### INCORPORATION BY REFERENCE

The disclosures of Japanese patent application No. JP2005-080631 filed on Mar. 18, 2005 including the specification, drawings and abstract are incorporated herein by reference.

What is claimed is:

1. A rental authentication system including an authentication device and a plurality of terminals that are connected via a network,
the authentication device comprising:
a biometric information receiving module receiving biometric information of a borrower from the terminal;
a first authentication module referring to a blacklist recorded with biometric information of beware-of persons, and authenticating as to whether the biometric information of the borrower matches with the blacklist or not;
a second authentication module referring to a past record database recoded with the biometric information of the borrowers having usage past records, and authenticating as to whether the biometric information of the borrower who does not match with the blacklist, matches with the past record database or not;
a result notifying module notifying the terminal of approval or non-approval for a rental operation on the basis of results of the authentication by the first authentication module and by the second authentication module; and
an update module updating the past record database if the rental operation is approved,
the terminal comprising:
a biometric information reading module reading the biometric information of the borrower;
a biometric information transmitting module transmitting the biometric information to the authentication device; and
a result receiving module receiving the approval or non-approval of the rental operation on the basis of the result of the authentication from the authentication device.

2. A rental authentication system according to claim 1, wherein if the rental operation is unapproved, the update module adds the biometric information of the borrower to the blacklist.

3. A rental authentication system according to claim 1, wherein when the past record database is recorded with the biometric information of the borrower who is in the middle of renting but is not recorded with the biometric information of the borrower who is not in the middle of renting, the result notifying module, as a result of the authentication by the second authentication module, notifies of the non-approval of the rental operation if the biometric information of the borrower matches with the past record database, and notifies of the approval of the rental operation if the biometric information of the borrower does not match with the past record database.

4. A rental authentication system according to claim 1, wherein when the past record database is recorded with the biometric information of the borrower and the usage past record in a way that associates the biometric information and the usage past record with each other,
the result notifying module, as a result of the authentication by the second authentication module, in a case where the biometric information of the borrower matches with the past record database, notifies of the approval for the rental operation if the usage past record associated therewith meets a predetermined condition, and notifies of the non-approval for the rental operation if the usage past record associated therewith does not meet the predetermined condition.

5. A rental authentication system according to claim 1, wherein the terminal comprises:
a storage module stored with identity information of the borrower and the biometric information of the borrower on a borrower-by-borrower basis in away that associates the identity information and the biometric information with each other;
a presenting module presenting, to an operator, the identity information associated with the biometric information read by the biometric information reading module; and
an approval/non-approval input module by which the operator inputs approval or non-approval corresponding to the identity information presented,
wherein if the input to the approval/non-approval input module is the approval, the biometric information transmitting module transmits the biometric information to the authentication device.

6. A rental authentication system according to claim 1, wherein the terminal comprises:
an identity input module by which the operator inputs identity information of the borrower;
a storage module stored with identity information of the borrower and the biometric information of the borrower on a borrower-by-borrower basis in a way that associates the identity information and the biometric information with each other;
a presenting module presenting, to an operator, the identity information associated with the biometric information read by the biometric information reading module; and
an approval/non-approval input module by which the operator inputs approval or non-approval corresponding to the identity information presented,
wherein if the biometric information read by the biometric information reading module is not stored on the storage module, the transmitting module transmits the biometric information and the identity information inputted by the identity input module to the authentication device, and
if the biometric information read by the biometric information reading module is stored on the storage module and if the input by the approval/non-approval input module is approval, the biometric information transmitting module transmits the biometric information to the authentication device.

7. A rental authentication system according to claim 6, wherein the past record information database is stored with the biometric information and the identity information in a way that associates the biometric information and the identity information with each other,
when the biometric information receiving module of the authentication device receives the identity information and the biometric information from the terminal, the second authentication module, after authenticating based on the past record information associated with the received identity information by referring to the past record information database, unless unauthenticated, authenticates based on the past record information associated with the received biometric information.

8. A rental authentication method executed by an authentication device and a plurality of terminals that are connected via a network,
the authentication device executing:
receiving biometric information of a borrower from the terminal;
referring to a blacklist recorded with biometric information of beware-of persons, and authenticating as to whether the biometric information of the borrower matches with the blacklist or not;
referring to a past record database recoded with the biometric information of the borrowers having usage past records, and authenticating as to whether the biometric information of the borrower who does not match with the blacklist, matches with the past record database or not;
notifying the terminal of approval or non-approval for a rental operation on the basis of results of the authentication; and
updating the past record database if the rental operation is approved,
the terminal executing:
reading the biometric information of the borrower;
transmitting the biometric information to the authentication device; and
receiving the approval or non-approval of the rental operation on the basis of the result of the authentication from the authentication device.

9. A rental authentication method according to claim 8, wherein if the rental operation is unapproved, the authentication device adds the biometric information of the borrower to the blacklist.

10. A rental authentication method according to claim 8, wherein when the past record database is recorded with the biometric information of the borrower who is in the middle of renting but is not recorded with the biometric information of the borrower who is not in the middle of renting, the authentication device, as a result of the authentication, notifies of the non-approval of the rental operation if the biometric information of the borrower matches with the past record database, and notifies of the approval of the rental operation if the biometric information of the borrower does not match with the past record database.

11. A rental authentication method according to claim 8, wherein when the past record database is recorded with the biometric information of the borrower and the usage past record in a way that associates the biometric information and the usage past record with each other, the authentication device, as a result of the authentication, in a case where the biometric information of the borrower matches with the past record database, notifies of the approval for the rental operation if the usage past record associated therewith meets a predetermined condition, and notifies of the non-approval for the rental operation if the usage past record associated therewith does not meet the predetermined condition.

12. A rental authentication method according to claim 8, wherein the terminal executes:
referring a storage module stored with identity information of the borrower and the biometric information of the borrower on a borrower-by-borrower basis in a way that associates the identity information and the biometric information with each other, and presenting, to an operator, the identity information associated with the readout biometric information;
receiving an input of approval or non-approval corresponding to the identity information from the operator; and
transmitting, if the input is the approval, the biometric information to the authentication device.

13. A rental authentication method according to claim 8, wherein
the terminal executes:
in the case of referring to a storage module stored with identity information of the borrower and biometric information of the borrower on a borrower-by-borrower basis in a way that associates the identity information and the biometric information with each other, if the storage module is not stored with the readout biometric information,
receiving an input of the identity information of the borrower from an operator; and
transmitting the inputted identity information and the readout biometric information of the borrower to the authentication device, and
the terminal executes:
in the case of referring to the storage module stored with the identity information of the borrower and the biometric information of the borrower on the borrower-by-borrower basis in a way that associates the identity information and the biometric information with each other, if the storage module is stored with the readout biometric information,
presenting the identity information associated with the readout biometric information to the operator;
receiving an input of the approval or non-approval corresponding to the identity information from the operator; and
transmitting, if the input is approval, the readout biometric information to the authentication device.

14. A rental authentication method according to claim 13, wherein the authentication device, when receiving the identity information and the biometric information from the terminal, after authenticating based on the past record information associated with the received identity information by referring to the past record information database, unless unauthenticated, authenticates based on the past record information associated with the received biometric information.

15. An authentication device comprising:
a biometric information receiving module receiving biometric information of a borrower from a terminal;
a first authentication module referring to a blacklist recorded with biometric information of beware-of persons, and authenticating as to whether the biometric information of the borrower matches with the blacklist or not;
a second authentication module referring to a past record database recoded with the biometric information of the borrowers having usage past records, and authenticating as to whether the biometric information of the borrower who does not match with the blacklist, matches with the past record database or not;
a result notifying module notifying the terminal of approval or non-approval for a rental operation on the basis of results of the authentication by the first authentication module and by the second authentication module; and
an update module updating the past record database if the rental operation is approved.

16. An authentication device according to claim 15, wherein if the rental operation is unapproved, the update module adds the biometric information of the borrower to the blacklist.

17. A rental authentication method executed by an authentication device connected to a plurality of terminals via a network,
the authentication device executing:
receiving biometric information of a borrower from the terminal;
referring to a blacklist recorded with biometric information of beware-of persons, and authenticating as to whether the biometric information of the borrower matches with the blacklist or not;
referring to a past record database recoded with the biometric information of the borrowers having usage past records, and authenticating as to whether the biometric information of the borrower who does not match with the blacklist, matches with the past record database or not;
notifying the terminal of approval or non-approval for a rental operation on the basis of results of the authentication; and
updating the past record database if the rental operation is approved.

18. A rental authentication method according to claim 17, wherein if the rental operation is unapproved, the authentication device adds the biometric information of the borrower to the blacklist.

19. A recording medium recorded with a rental authentication program executed by an authentication device connected to a plurality of terminals via a network, the program comprising:
receiving biometric information of a borrower from the terminal;
referring to a blacklist recorded with biometric information of beware-of persons, and authenticating as to whether the biometric information of the borrower matches with the blacklist or not;
referring to a past record database recoded with the biometric information of the borrowers having usage past records, and authenticating as to whether the biometric information of the borrower who does not match with the blacklist, matches with the past record database or not;
notifying the terminal of approval or non-approval for a rental operation on the basis of results of the authentication; and
updating the past record database if the rental operation is approved.

20. A recording medium according to claim 19, wherein if the rental operation is unapproved, the biometric information of the borrower is added to the blacklist.
